(19) United States
(12) Patent Application Publication
(10) Pub. No.: US 2020/0163317 A1
(43) Pub. Date: May 28, 2020

(54) SPECIAL-SHAPED DIP NET PROVIDED WITH EXTERNAL HANDLE

(71) Applicant: HANGZHOU FUFAN INDUSTRY CO., LTD., Hangzhou (CN)

(72) Inventors: HONGJIAN XU, HANGZHOU (CN); SHU LIN, HANGZHOU (CN); LINRONG HONG, HANGZHOU (CN); HUIHAI GE, HANGZHOU (CN)

(73) Assignee: HANGZHOU FUFAN INDUSTRY CO., LTD.

(21) Appl. No.: 16/234,418

(22) Filed: Dec. 27, 2018

(30) Foreign Application Priority Data
Nov. 26, 2018 (CN) 2018114172567

(51) Int. Cl. A01K 77/00

(52) U.S. Cl. CPC A01K 77/00

(57) ABSTRACT

A special-shaped dip net provided with an external handle comprises a net rack, a dip net rod and a handle, wherein a dip net rod mounting base is arranged at the tail end of the net rack and is provided with a first lock structure; the dip net rod penetrates through the dip net rod mounting base, clamping grooves matched with the first lock structure are separately formed in the front end and the rear end of the dip net rod, and the dip net rod is locked on the dip net rod mounting base through the first lock structure; the handle comprises two connecting parts and a handheld part, the two connecting parts are symmetrically fixed to the left and the right side of the dip net rod mounting base and incline upwards from back to front, and the handheld part has two ends fixed to the connecting parts on the two sides and is higher than the dip net rod. The dip net rod and the handle are cooperatively used for scooping fish, the dip net can be lifted more easily, and the dip net rod is not prone to deformation.

### BACKGROUND OF THE INVENTION

### 1. Technical Field

The present invention relates to the field of fishing gear, in particular to a special-shaped dip net provided with an external handle.

### 2. Description of Related Art

In the fishing process, it is an indispensable step to scoop fish with dip nets. Particularly when big fish are caught, it will be very difficult to get the big fish onto the bank without dip nets, and even the fish can escape, which makes all previous labor in vain. For this reason, dip nets are indispensable fishing gear, and the structure and quality of the dip nets are particularly important for fishing. Existing dip nets on the market have various defects, for instance, these dip nets have to be assembled on site when used, which will spend a lot of time and labor; and these dip nets are large in size and poor in bearing capacity and are provided with long rods, thereby being inconvenient to carry.

At present, the dip nets on the market are mainly composed of a fishnet and a net rod, wherein the net rod is usually formed by detachably connecting a thin long net rod section and a thick short net rod section, and the fishnet is fixed to the long net rod section. The dip nets can be configured in two forms in use as needed: long dip net formed by the long net rod section, the short net rod section and the fishnet, and short dip net formed by the long net rod section and the fishnet by removing the short net rod section. Chinese Patent Application No. 201721784054.7 discloses a fishing dip net rod, which comprises a long net rod section and a short net rod section to be detachably connected with a connector of the fishnet, a connector is arranged at the bottom end of the long net rod section, connecting sleeves matched with the connector are arranged at the top end of the long net rod section and the top end of the short net rod section, a mounting cavity used for accommodating a fishing float is formed in the short net rod section, anti-skid layers are arranged on the surface of the long net rod section and the surface of the short net rod section and are formed by binding wires sequentially wound on the net rod sections in the axial direction.

Although the length of dip nets is made adjustable through the above technical solution, the long net rod section, the short net rod section and the fishnet are still detachably connected and have to be troublesomely assembled on site, the stability of joints is affected in the repeated assembling and disassembling process, the overall strength of the net rod is reduced, and consequentially, the net rod is prone to breakage due to malfunctions of the joint between the long net rod section and the short net rod section when a big fish is scooped. When the dip nets are used for scooping fish, the user holds the dip net rod to scoop fish at a distance, and according to the lever principle, it will be very difficult for the user to scoop fish due to the large force; and because all the acting force is borne by the dip net rod, the dip net rod is prone to deformation and breakage, and which in turn shortens the service life of the dip nets.

### BRIEF SUMMARY OF THE INVENTION

The object of the present invention is to overcome the defects of the prior art by providing a disassembly-free stretchable special-shaped dip net, which is provided with an external handle, can bear forces reasonably when used for scooping fish, and can scoop fish more effortlessly.

For the sake of a brief description of this application, the applicant omits ‘string bag’ in the following text description, and the string bag is not shown in the figures either. Those skilled in this field would appreciate that the string bag should be attached to or mounted on the net rack when the special-shaped dip net in this patent is used.

The technical solution provided by the present invention to fulfill the above objective is as follows:

The present invention relates to a special-shaped dip net provided with an external handle. The special-shaped dip net comprises a net rack, a dip net rod and a handle. A dip net rod mounting base is arranged at the tail end of the net rack and is provided with a first lock structure. The dip net rod penetrates through the dip net rod mounting base. Clamping grooves matched with the first lock structure are formed in the front end and the rear end of the dip net rod. The dip net rod is locked on the dip net rod mounting base through the first lock structure. The handle comprises two connecting parts and a handheld part, wherein the two connecting parts are symmetrically fixed to the left side and the right side of the dip net rod mounting base and incline upwards from back to front, and the handheld part has two ends fixed to the connecting part on the two sides and is higher than the dip net rod.

Preferably, the first lock structure comprises a first switch, a first bolt and a first reset spring, wherein the middle of the first switch is hinged to the dip net rod mounting base, the first reset spring and the first bolt are separately arranged at the front end and the rear end of the lower surface of the first switch, the first reset spring has an upper end and a lower end separately making contact with the first switch and the dip net rod, and the first bolt has a top fixed to the first switch and a bottom matched with the clamping grooves.

Preferably, the dip net rod comprises a front dip net rod section and a rear dip net rod section, wherein the clamping grooves are formed in the front end and the rear end of the front dip net rod section, a lantern ring is arranged at the tail end of the front dip net rod section and is provided with a second lock structure, clamping holes matched with the second lock structure are formed in the front end and the rear end of the rear dip net rod section, and the rear dip net rod section penetrates through the lantern ring to be inserted into the front dip net rod section and is locked on the lantern ring through the second lock structure.

Preferably, the second lock structure comprises a second switch, a second reset spring and a second bolt, wherein the middle of the second switch is hinged to the lantern ring, the second reset spring and the second bolt are respectively arranged at the front end and the rear end of the lower surface of the second switch, the second reset spring has an upper end and a lower end separately making contact with the second switch and the rear dip net rod section, and the second bolt has a top fixed to the second switch and a bottom matched with the clamping holes.

Preferably, the front dip net rod section comprises a lower arc-shaped part and an upper planar part, a plurality of reinforcing ribs are arranged in the front dip net rod section, and the clamping grooves are formed in the planar part.

Preferably, a cavity is formed in the front end of the dip net rod, a torch is arranged in the cavity, an elastic touch switch is arranged at the tail end of the torch and makes contact with the rear end face of the cavity, a limit collar is arranged at the front end of the torch, a through hole is formed in the center of the limit collar, a transparent cover plate is arranged at the through hole, a spacing ring larger than the through hole is arranged on a rear half part of the transparent cover plate, and the rear end face of the transparent cover plate makes contact with the front end of the torch.

Preferably, a plurality of protrusions are arranged on the surface of the handheld part.

Preferably, a limit ring is arranged at the front end of the dip net rod.

Preferably, a limit ring is arranged at the front end of the front dip net rod.

By adoption of the above technical solution, the present invention has the following beneficial effects over the prior art:

1. The handle is arranged at the front end of the dip net rod mounting base of the dip net, and the user grips the dip net rod with one hand and holds the handle with the other hand when using the dip net, so that the force is applied more reasonably, fish can be scooped more easily, and meanwhile, the load of the dip net rod is reduced to avoid deformation of the dip net rod.

2. The dip net rod of the special-shaped dip net provided with the external handle is divided into the front section and the rear section, the front section and the rear section are both of a stretchable structure and are locked through the lock structures, so that the dip net rod has a small size when stored; in use, the front dip net rod section is independently pulled out or the front dip net rod section and the rear dip net rod section are both pulled out according to the fish scooping distance, and then the front dip net rod section and the rear dip net rod section are locked through the first lock structure and the second lock structure; and compared with an existing dip net needing to be assembled on site, the dip net of such structure is convenient to unfold in use, the net rack, the front dip net rod section and the rear dip net rod section are locked and connected more reliably, and thus, the dip net of the present invention is not prone to damage and is long in service life.

3. The dip net of the present invention is provided with the torch, and the torch can emit lights to attract fish at night.

### BRIEF DESCRIPTION OF THE SEVERAL VIEWS OF THE DRAWINGS

FIG. 1 is a perspective view of a special-shaped dip net provided with an external handle;

FIG. 2 is a top view of the special-shaped dip net provided with the external handle;

FIG. 3 is a vertical sectional view of joint A in FIG. 2 in the length direction;

FIG. 4 is a vertical sectional view of joint B in FIG. 2 in the length direction;

FIG. 5 is a sectional view of a rod piece of a front dip net rod section;

FIG. 6 is a view of the special-shaped dip net provided with the external handle in the state where the dip net rod is completely folded; and

FIG. 7 is a view of the special-shaped dip net provided with the external handle when used for scooping fish in a short distance.

The meaning of the reference numerals: 1, net rack; 2, dip net rod; 3, dip net rod mounting base; 4, handle; 5, first lock structure; 6, torch; 21, clamping groove; 22, front dip net rod section; 23, rear dip net rod section; 24, lantern ring; 25, second lock structure; 26, clamping hole; 27, second switch; 28, second reset spring; 29, second bolt; 41, connecting part; 42, handheld part; 43, protrusion; 51, first switch; 52, first bolt; 53, first reset spring; 61, elastic touch switch; 62, limit collar; 63, transparent cover plate; 64, limit ring; 221, arc-shaped part; 222, planar part; 223, reinforcing rib.

### DETAILED DESCRIPTION OF EMBODIMENTS OF THE INVENTION

For a better understanding of the present invention, the present invention is expounded below with reference to embodiments. The following embodiments are used to explain the present invention, but are not intended to limit the scope of the present invention.

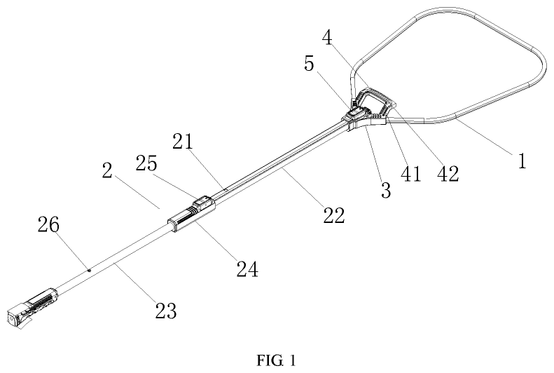

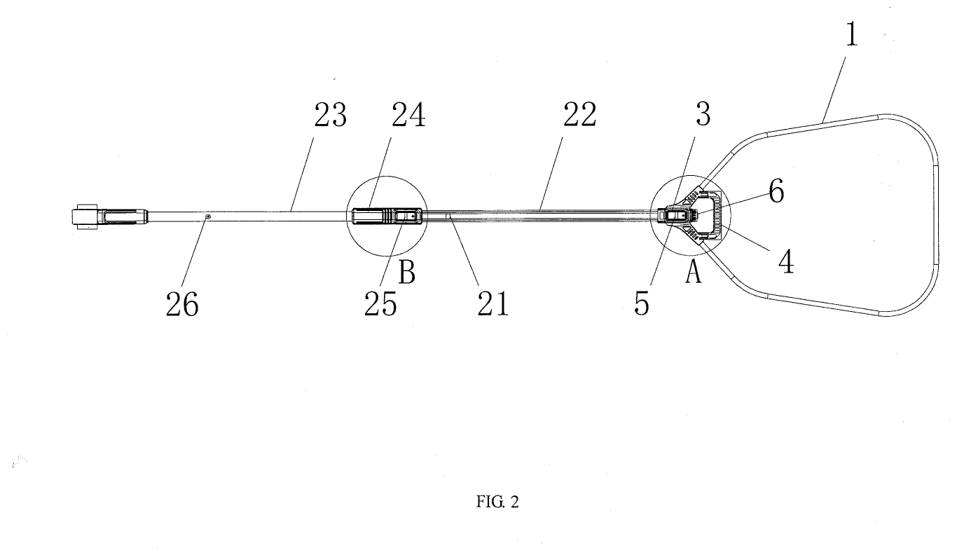

Referring to FIG. 1 and FIG. 2, a special-shaped dip net provided with an external handle comprises a net rack 1, a dip net rod 2 and a handle 4. The dip net rod 2 is of a stretchable structure and comprises a front dip net rod section 22 and a rear dip net rod section 23. A dip net rod mounting base 3 is arranged at the tail end of the net rack 1 and is provided with a first lock structure 5. The front dip net rod section 22 penetrates through the dip net rod mounting base 3. Clamping grooves 21 matched with the first lock structure 5 are separately formed in the front end and the rear end of the front dip net rod section 22.

As shown in FIG. 5, the front dip net rod section 22 comprises a lower arc-shaped part 221 and an upper planar part 222. The clamping grooves 21 are located in the planar part 222. A plurality of reinforcing ribs 223 are arranged in the front dip net rod section 22. The lower arc-shaped part and the upper planar part of the front dip net rod section 22 can prevent relative rotation between the front dip net rod section and the rear dip net rod section and can also prevent the fish scooping angle against deviations when the front dip net rod section 22 rotates relative to the hand in the fish scooping process. In addition, the clamping grooves 21 can be turned more easily in the planar part 222 than in a traditional dip net rod with a circular section. The overall strength of the front dip net rod section 22 is improved by the reinforcing ribs 223, so that the front dip net rod section 22 is protected against deformation or bend.

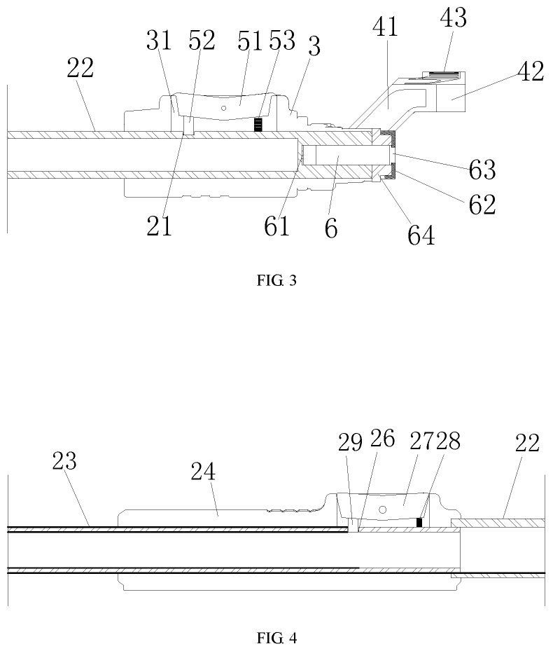

The detailed structure of the joint between the dip net rod mounting base 3 and the front dip net rod section 22 is shown in FIG. 3. As shown in FIG. 3, a first mounting hole is formed in the top of the dip net rod mounting base 3, and the middle of the first lock structure 5 is hinged into the first mounting hole 11. The first lock structure 5 comprises a first switch 51. A first reset spring 53 and a first bolt 52 are separately arranged at the front end and the rear end of the lower surface of the first switch 51. The bottom of the first reset spring 53 makes contact with the front dip net rod section 22, and the top of the first reset spring 53 is arranged in a limit hole of the first switch 51 and makes contact with a front half part of the first switch 51. The top of the first bolt 52 is fixed to a rear half part of the first switch 51, and the bottom of the first bolt 52 is matched with the clamping grooves 21. When the front dip net rod section 22 is stretched to the maximum extent, the first bolt 52 is buckled in the clamping groove 21 in the front end of the front dip net rod section 22. A limit ring 64 is arranged at the front end of the front dip net rod section 22. When the front dip net rod section 22 is inserted into the net rack, the first bolt 52 is buckled in the clamping groove 21 in the rear end of the front dip net rod section 22. When the front dip net rod section 22 is completely pulled out, the rear side of the limit ring 64 abuts against the front side of the dip net rod mounting base 3, and the first bolt 52 is inserted into the clamping groove 21 in the front end of the front dip net rod section 22.

As shown in FIGS. 1-3, the handle 4 is arranged at the front end of the dip net rod mounting base 3 and comprises two connecting parts 41 and a handheld part 42, wherein the two connecting parts 41 are symmetrically fixed to the left side and the right side of the dip net rod mounting base 3 and incline upwards from back to front; the handheld part 42 has two ends fixed to the connecting parts on the two sides and is higher than the dip net rod 2, so that the front dip net rod section 22 will not collide with the handheld part 42 when stretching forwards or backwards; and protrusions 43 are arranged on the surface of the handheld part 42 and are able to increase the friction between the handheld part 42 and the hand.

As shown in FIGS. 1-3, a cavity is formed in the front end of the front dip net rod section 22, an external thread is arranged at the forefront of the limit ring 64, and a limit collar 62 is arranged at the external thread in a threaded connection manner. A through hole communicated with the cavity is formed in the center of the limit collar 62. A torch 6 is arranged in the cavity and is provided with an elastic touch switch 61. The elastic touch switch 61 is located on the rear end face of the torch 6 and makes contact with a rear end plate of the cavity of the front dip net rod section 22. A transparent cover plate 63 is arranged at the through hole. A spacing ring is arranged on a rear half part of the transparent cover plate 63, which means that the transparent cover plate 63 is in a step shape with a front half part having a smaller diameter than a rear half part. The front half part of the transparent cover plate 63 is inserted into the through hole, and the rear half part (the spacing ring) of the transparent cover plate 63 is arranged between the torch 6 and the limit collar 62. In order to prevent water from entering the cavity when fish are scooped, the outer circle of the transparent cover plate 63 can be wrapped with a seal ring. When the transparent cover plate 63 is pressed, the whole torch 6 moves backwards to push the elastic touch switch 61, and thus, on-off of the torch 6 is controlled. The torch 6 can also be provided with a control chip, wherein the control chip is mounted in the torch 6 and is used to control the torch 6 to emit a near light, a distant light, a scattered light, a twinkling light or other lights. For instance, the near light is emitted by the torch 6 if the transparent cover plate 63 is pressed once; the distant light is emitted by the torch 6 if the transparent cover plate 63 is pressed twice; the scattered light is emitted by the torch 6 if the transparent cover plate 63 is pressed three times; the twinkling light is emitted by the torch 6 if the transparent cover plate 63 is pressed four times; and the torch is turned off if the transparent cover plate 63 is pressed five times. Lights emitted by the torch 6 are used to attract fish, and lights with different degrees of brightness can attract different types of fish.

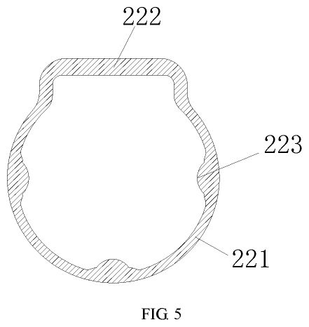

As shown in FIG. 1 and FIG. 2, a lantern ring 24 is fixed to the tail end of the front dip net rod section 22, and a second lock structure 25 is arranged on the lantern ring 24. The connection structure of the front dip net rod section, the rear dip net rod section and the lantern ring 24 is shown in FIG. 4. As shown in FIG. 4, the rear dip net rod section 23 penetrates through the lantern ring 24 and is inserted into the front dip net rod section 22, and clamping holes 26 matched with the second lock structure 25 are separately formed in the front end and the rear end of the rear dip net rod section 23. A second mounting hole 14 is formed in the top of the lantern ring 24. The second lock structure 25 comprises a second switch 27. The middle of the second switch 27 is hinged into the second mounting hole. A second reset spring 28 and a second bolt 29 are separately arranged at the front end and the rear end of the lower surface of the second switch 27. The bottom of the second reset spring 28 makes contact with the rear dip net rod section 23, and the top of the second reset spring 28 is mounted in a limit hole in the lower surface of the second switch 27 and makes contact with a front half part of the second switch 27. The top of the second bolt 29 is fixed to a rear half part of the second lock structure 25, and the bottom of the second bolt 29 is matched with the clamping holes 26.

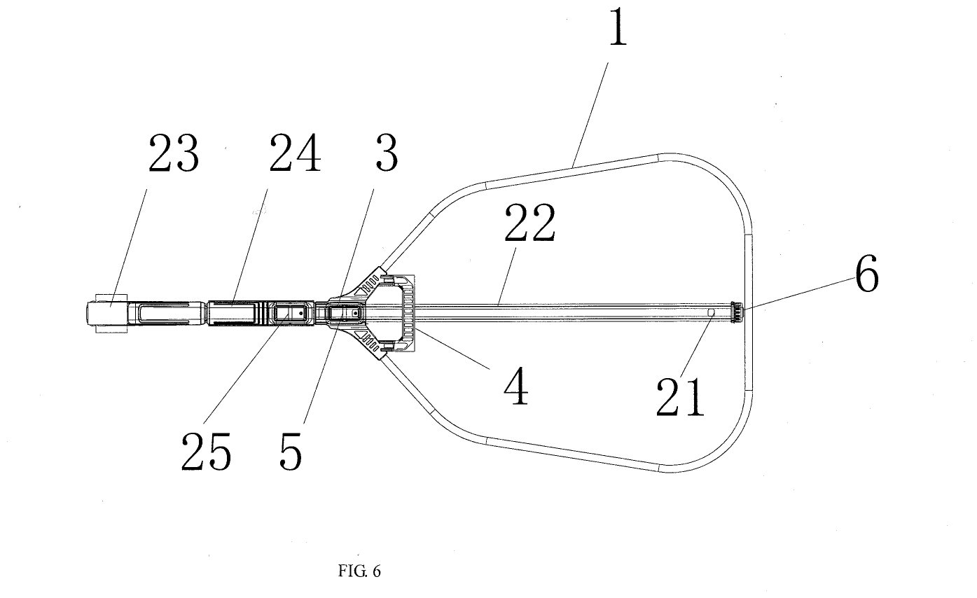

FIG. 6 is a view of the special-shaped dip net in a non-work state. As shown in FIG. 6, the rear dip net rod section 23 is completely inserted into the front dip net rod section 22, and the second lock structure 25 is buckled in the clamping hole 26 in the rear end of the rear dip net rod section 23; and the front dip net rod section 22 is completely stretched into the net rack 1, and the first lock structure 5 is buckled in the clamping groove 21 in the rear end of the front dip net rod section 22.

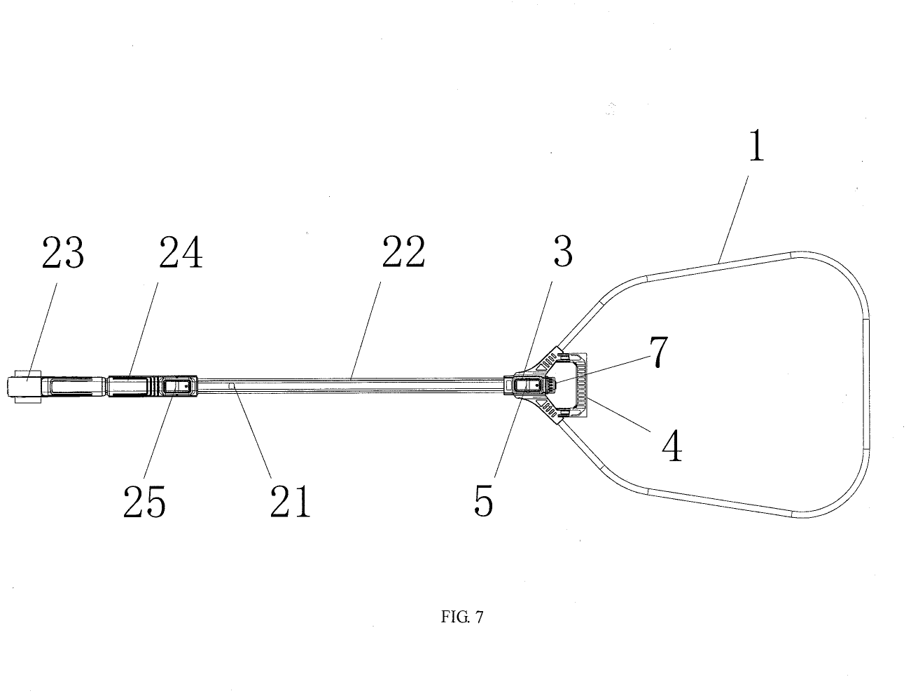

As shown in FIG. 7, when the special-shaped dip net provided with the external handle is used, the front half part of the first switch 51 is pressed, the first switch 51 rotates to push the first reset spring 53, and at this moment, the front dip net rod section 22 is released by the first bolt 52 and is pulled out; when the front dip net rod section 22 is completely pulled out, release the first switch 51. Then, the limit ring 64 abuts against the dip net rod mounting base 3, and under the effect of the first reset spring 53, the first bolt 52 falls into the clamping groove 21 in the rear end of the front dip net rod section 22; and the front dip net rod section 22 is automatically buckled and is prevented from moving forwards or backwards, and then fish close to the bank or the ship can be scooped. After the fish are scooped, the user can easily lift the dip net by gripping the front dip net rod section 22 with one hand and holding the handle 4 with the other hand.

As shown in FIG. 1 or 2, if fish are still out of reach after the front dip net rod section 22 is completely pulled out, the front half part of the second switch 27 is pressed, the second switch 27 rotates to push the second reset spring 28, and at this moment, the rear dip net rod section 23 is released by the second bolt 29 and is pulled out; when the rear dip net rod section 23 is completely pulled out, release the second switch 27. Then the second bolt 29 falls into the clamping hole 26 in the rear end of the rear dip net rod section 23, and under the effect of the second reset spring 28, the rear dip net rod section 23 is automatically buckled, and then fish away from the ship or the bank can be scooped; and after the fish are scooped, the user can easily lift the dip net by gripping the front dip net rod section 22 or the rear dip net rod section 23 with one hand and holding the handle 4 with the other hand.

When the special-shaped dip net is used for fishing at night, the transparent cover plate 63 is pressed, and then the whole torch 6 moves forwards or backwards to push the elastic touch switch 61 to control on-off of the torch 6. The torch 6 can emit lights with different degrees of brightness or different flicker frequencies to attract different types of fish by pressing the transparent cover plate 63 for different times.

After fishing, the front dip net rod section 22 and the rear dip net rod section 23 can be folded. The way of folding the special-shaped dip net provided with the external handle is similar to the way of pulling out of the front dip net rod section 22 and the rear dip net rod section 23 and is no longer stated herein.

The present invention is expounded above with reference to embodiments, but the above embodiments are only preferred ones of the present invention and are not intended to limit the implementation scope of the present invention. All equivalent transformations and improvements achieved without deviating from the application scope of the present invention should also fall within the protection scope of the present invention.

1. A special-shaped dip net provided with an external handle, comprising a net rack, a dip net rod and a handle, wherein a dip net rod mounting base is arranged at a tail end of the net rack and is provided with a first lock structure; the dip net rod penetrates through the dip net rod mounting base, clamping grooves matched with the first lock structure are separately formed in a front end and a rear end of the dip net rod, and the dip net rod is locked on the dip net rod mounting base through the first lock structure; and the handle comprises two connecting parts and a handheld part, the two connecting parts are symmetrically fixed to a left side and a right side of the dip net rod mounting base and incline upwards from back to front, and the handheld part has two ends fixed to the connecting parts on the two sides and is higher than the dip net rod.

2. The special-shaped dip net provided with the external handle according to claim 1, wherein the first lock structure comprises a first switch, a first bolt and a first reset spring, a middle of the first switch is hinged to the net rod mounting base, the first reset spring and the first bolt are separately arranged at a front end and a rear end of a lower surface of the first witch, the first reset spring has an upper end and a lower end separately making contact with the first switch and the dip net rod, and the first bolt has a top fixed to the first switch and a bottom matched with the clamping grooves.

3. The special-shaped dip net provided with the external handle according to claim 1, wherein the dip net rod comprises a front dip net rod section and a rear dip net rod section, the clamping grooves are formed in a front end and a rear end of the front dip net rod section, a lantern ring is arranged at a tail end of the front dip net rod section, a second lock structure is arranged on the lantern ring, clamping holes matched with the second lock structure are formed in a front end and a rear end of the rear dip net rod section, and the rear dip net rod section penetrates through the lantern ring to be inserted into the front dip net rod section and is locked on the lantern ring through the second lock structure.

4. The special-shaped dip net provided with the external handle according to claim 3, wherein the second lock structure comprises a second switch, a second reset spring and a second bolt, a middle of the second switch is hinged to the lantern ring, the second reset spring and the second bolt are respectively arranged at a front end and a rear end of a lower surface of the second switch, the second reset spring has an upper end and a lower end separately making contact with the second switch and the rear dip net rod section, and the second bolt has a top fixed to the second switch and a bottom matched with the clamping holes.

5. The special-shaped dip net provided with the external handle according to claim 3, the front dip net rod section comprises a lower arc-shaped part and an upper planar part, a plurality of reinforcing ribs are arranged in the front dip net rod section, and the clamping grooves are formed in the planar part.

6. The special-shaped dip net provided with the external handle according to claim 1, a cavity is formed in the front end of the dip net rod, a torch is arranged in the cavity, an elastic touch switch is arranged at a tail end of the torch and makes contact with a rear end face of the cavity, a limit collar is arranged at a front end of the torch, a through hole is formed in a center of the limit collar, a transparent cover plate is arranged at the through hole, a spacing ring larger than the through hole is arranged on a rear half part of the transparent cover plate, and a rear end face of the transparent cover plate makes contact with the front end of the torch.

7. The special-shaped dip net provided with the external handle according to claim 1, a plurality of protrusions are arranged on a surface of the handheld part.

8. The special-shaped dip net provided with the external handle according to claim 1, a limit ring is arranged at the front end of the dip net rod.

9. The special-shaped dip net provided with the external handle according to claim 3, a limit ring is arranged at the front end of the front dip net rod section.
